(19) United States
(12) Patent Application Publication
(10) Pub. No.: US 2012/0175558 A1
(43) Pub. Date: Jul. 12, 2012

(54) Nano-porous precursors for opto-ceramics via novel reactive dissolution

(76) Inventors: Samuel David Conzone, Clarks Summit, PA (US); Carol Click, Clarks Green, PA (US)

(21) Appl. No.: 11/878,626

(22) Filed: Jul. 25, 2007

(51) Int. Cl. C09K 11/08; C09K 11/63; C09K 11/78; C09K 11/80; C03B 19/10; B29C 67/20

(52) U.S. Cl. 252/301.4 R; 65/21.2; 65/21.3; 264/43; 264/42

(57) ABSTRACT

The invention relates to a process for preparing porous glass particles suitable for use as precursor materials for production of an opto-ceramic element. The process comprises: providing particles of a soluble glass composition comprising at least one soluble component, at least one component having low solubility in an aqueous solution, and at least one lasing dopant which also has a low solubility in the aqueous solution; and immersing the particles in an aqueous solution having low solubility for said at least one component and said at least one lasing dopant, to thereby dissolve substantially all of the soluble portions of the glass particles.

The present invention relates to a process for preparing porous particles from solid materials, especially particles suitable for use as precursor materials to be sintered to form opto-ceramic materials, as well as novel precursor materials obtained from the process. Additionally, the present invention relates to a method for using the nano-porous particles, obtained from the inventive process, to produce opto-ceramic compositions, especially opto-ceramic materials for use in high energy laser applications.

### FIELD OF THE INVENTION

There is a growing interest and need for the development of new materials and processes for the production of solid-state, high-energy laser systems that are more compact and portable than current large and cumbersome chemical lasers. New solid-state laser systems are presently being developed that will deliver >10 kW (preferably >100 kW) of electromagnetic radiation. However, most current high-energy laser systems have substantial limitations. For example, chemical lasers are large and require hazardous chemical inputs and outputs. On the other hand, glass lasers have the advantage of high peak power, but are limited to use at low repetition rates due to their poor thermo-mechanical properties. Single crystal and opto-ceramic lasers have limitations on the size of lasing materials that can be produced with sufficient optical quality and cost.

One class of materials being developed for the next generation of high-energy laser systems are optically transparent, polycrystalline ceramic laser gain materials. These so-called “opto-ceramics” are polycrystalline materials that are processed in a manner to produce an optic element with high internal transmittance (>90%) and an index homogeneity of less than 1000 ppm. Opto-ceramics are a potential replacement for single crystal materials (YAG, Sapphire, etc.), which have proven to be useful commercially, but are expensive, or even impossible, to produce in large formats (>10×10×2 cm³). Typical single crystal growth mechanisms require high purity raw materials, high temperature processing, long growth times, result in low yields and anisotropic materials. Opto-ceramic processing represents an alternative method for manufacturing material with high homogeneity, transparency and isotropic properties. Additionally, optical materials that have high refractive indices and/or high dispersion typically are unstable when formed as traditional glasses. Therefore, such optical materials are increasingly being made from opto-ceramics. Further information on the state of the art of ceramic lasers can be found in, for example, Harris, D C, TI History of development of polycrystalline optical spinel in the U.S.,” PROCEEDINGS OF THE SOCIETY OF PHOTO-OPTICAL INSTRUMENTATION ENGINEERS(SPIE), 2005 (5786), 1-22, and Huie, J, Gentilman, R, “Characterization of transparent polycrystalline yttrium aluminum garnet (YAG) fabricated from nano-powder” PROCEEDINGS OF THE SOCIETY OF PHOTO-OPTICAL INSTRUMENTATION ENGINEERS(SPIE), 2005 (5786), 251-257.

The raw materials or sintering precursors commonly used for manufacturing opto-ceramics are crystalline nano-particles. These nano-particles have very high purity (>99.99%), and typically have a particle size of 50-500 nm in diameter. Precursors exhibiting such properties enable the formation of highly densified (≈100% of full density), fine-grained opto-ceramic micro/nanostructures during sintering and thus limit optical scattering. Nano-particles are used because of their high specific surface area, typically >50 m²/g, which facilitates solid state sintering. A higher specific surface area typically enhances solid state sintering (as a main driver for material consolidation is the reduction in surface area during heating at high temperatures) and thus is generally preferable for opto-ceramic precursor materials.

When used for manufacturing opto-ceramics, the nano-particles can be mixed (i.e., via ball or attrition milling) with binders, dispersants, and sintering aids and then spray dried to form ˜50 micron agglomerates. This spray dried powder is then subjected to cold, isostatic pressing to form a shaped body which is then vacuum sintered to full density at temperatures of ˜1700° C. The properties of the resultant sintered opto-ceramic material are dependent upon the removal of porosity, control of grain growth/exaggerated grain growth, as well as chemical homogeneity. Currently, however, the size of opto-ceramics is severely limited. Typically, the final products are limited in size to less than 10×10×2 cm³. The size is limited by the ability to produce pore-free, controlled grain growth, and optically homogenous materials. These three parameters are all dependent upon not only the sintering and the pressing steps, but also ultimately dependent on the precursor materials themselves.

Current nano-particle precursors for opto-ceramics have several disadvantages. While microscopic particles tend to be free flowing, and readily handled without dispersants, nano-particles tend to agglomerate upon formation, during storage, and/or during particle processing. Such agglomeration results in poor particle handling characteristics (i.e., poor particle flow, inhomogeneous mixing, inhomogeneous pressing, etc). The non-uniform, micron-sized agglomerates are also a source for exaggerated grain growth and/or pore/defect growth during sintering. Finally, most nanoparticulate fabrication techniques are small scale and not suited for volume production (multiple tons/day).

As a result, to be used effectively, nano-particles are often dispersed in solutions using complex chemistries and dispersing agents in an attempt to prevent agglomeration. However, the use of dispersing agents and chemical constituents within such dispersing solutions adds complexity (and the potential introduction of impurities) to the sintering precursor formulation. Further, even with complex, liquid-based processing, it is still often impossible to prevent the non-uniform agglomeration of some small percentage of nanoparticles. Even a small percentage of agglomeration can lead to non-uniform porosity, exaggerated grain growth, chemical inhomogeneities and ultimately result in defects that hinder the optical performance (transparency) of the final opto-ceramic (i.e., scattering centers are formed).

Additionally, nano-particles, with their associated handling problems, do not permit the precursor composition to be easily varied. Nano-particles of distinctly different chemistries (e.g., Y₂O₃, Al₂O₃, Nd₂O₃) are difficult to uniformly disperse in admixtures. This often results in an opto-ceramic which exhibits chemical inhomogeneity, which again affects the final optical performance (index variability, scattering, transparency) of the final opto-ceramic.

Having an easy-to-handle (micron-sized) material that can be used as a precursor for opto-ceramics and that has high specific surface area and chemical homogeneity, without having the problems of non-uniform nano-particle agglomeration, would be advantageous.

Thus, there is a need for efficient processes for producing microscopic particles as precursors for the manufacture of opto-ceramics, wherein the processes permit the production of a wider variety of compositions and/or permit the production of highly pure precursor materials having high specific surface area (preferably >20 m²/g, more preferably >100 m²/g, and most preferably >150 m²/g), that are free flowing, chemically homogeneous, and do not require dispersants for handling. Additionally, there is a need for a production process for such nano-porous precursor materials that is suited for industrialization (high volume) and can be specifically tailored for use in the manufacture of opto-ceramics for high energy laser applications.

U.S. Pat. No. 6,358,531, the entire disclosure of which is hereby incorporated by reference, discloses a process that employs glass particles as a starting material to prepare a product which is composed of a shell filled with colloidal particles or gel, a product composed of concentric shells, or a porous, homogenous gel product. The process involves:

(a) forming particles of an alkali borate glass composition that contains one or more cations which will react with an aqueous solution containing an anion reactive with the cation to form an aqueous insoluble material having a solubility limit of less than about 0.01 wt. percent;

(b) immersing the glass composition particles in the aqueous solution whereby the particles react and form the insoluble material which is essentially the same size as starting particles, the alkali and borate dissolving from the glass particles; and

(c) continuing the reaction until the alkali and boron are substantially completely dissolved from the glass particles.

U.S. Pat. No. 6,358,531 discloses that the products formed by process can be use as fillers in resins, polymers, metals, and paints. Also, biodegradable, hollow/porous products can be used for drug delivery of, for example, antibiotics or chemotherapeutic agents. Also, U.S. Pat. No. 6,358,531 discloses that porous/hollow shells products composed of refractory oxides, such as aluminum oxide, can be sintered to form high purity, high temperature insulation. Other uses include in vivo delivery of calcium and phosphorous to accelerate the bone growth, catalyst supports, filters, targets for laser fusion, precursors for nano-sized powders, thin surface films, and agents for removal of hazardous species from solution.

### SUMMARY OF THE INVENTION

According to one aspect of the invention there is provided a process for manufacturing nano-porous particles, particularly suitable for use in the manufacture opto-ceramic materials for high energy laser applications. The process involves the use of a glass/solution reaction process, such as described in U.S. Pat. No. 6,358,531, adapted for the production of precursors for manufacturing opto-ceramic materials for use in high energy laser applications.

According to one embodiment of the invention, the process comprises:

providing a glass material (in the form of particulates, fibers, microspheres, plates, thin films, thin sheets, rods, fragments, but most preferably micron-sized particulates and/or microspheres) of a soluble glass composition comprising at least one soluble component, at least one component having low solubility in an aqueous solution, and at least one lasing dopant which also has a low solubility in the aqueous solution; and

immersing the particles in an aqueous solution having low solubility for said at least one component and said at least one lasing dopant, to thereby dissolve substantially all of the soluble portions of the glass material.

According to one embodiment of the invention, the process comprises:

providing a glass material (preferably micron-sized particulates and/or microspheres) of an alkali-borate glass composition comprising at least one alkali metal oxide, B₂O₃, at least one component having low solubility in an aqueous solution, and at least one lasing dopant which also has a low solubility in the aqueous solution; and

immersing the particles in an aqueous solution having low solubility for said at least one component and said at least one lasing dopant, to thereby dissolve substantially all of the soluble borate and alkali metal portions of the glass material.

According to one embodiment of the invention, the process comprises:

providing a glass material (preferably micron-sized particulates and/or microspheres) of an alkaline earth metal-borate glass composition comprising at least one alkaline earth metal oxide, B₂O₃, at least one component having low solubility in an aqueous solution, and at least one lasing dopant which also has a low solubility in the aqueous solution; and

immersing the particles in an aqueous solution having low solubility for said at least one component and said at least one lasing dopant, to thereby dissolve substantially all of the soluble borate and alkaline metal portions of the glass material.

According to one embodiment of the invention, the process comprises:

providing a glass material (preferably micron-sized particulates and/or microspheres) of a borate glass composition, which is essentially free of alkali metals and/or alkaline earth metals, comprising B₂O₃, at least one component having low solubility in an aqueous solution, and at least one lasing dopant which also has a low solubility in the aqueous solution; and

immersing the particles in an aqueous solution having low solubility for said at least one component and said at least one lasing dopant, to thereby dissolve substantially all of the soluble portions of the glass material.

According to a further embodiment, the invention relates to a process for the production of nano-porous precursor materials, the process comprising:

melting a glass composition comprising B₂O₃, at least one component having low solubility in an aqueous solution, at least one lasing dopant which also has a low solubility in the aqueous solution, and optionally containing alkali metal oxides and/or alkaline earth metal oxides;

producing particles by (a) casting the melted composition, crushing and/or milling composition as casted, and optionally sieving the resultant particles, or (b) direct melt spraying the melted composition (such as melt spraying using shockwaves as described in copending and commonly-assigned patent application [Attorney Docket No. RDD-12]);

immersing the particles in an aqueous solution having low solubility for said at least one component and said at least one lasing dopant, to thereby dissolve substantially all of the soluble portions of the glass particles and precipitate the desired products (e.g., Nd/Y/Al-hydroxide);

rinsing the reacted particles to remove dissolved species and the aqueous solution;

pressing the resultant particles to produce a green body of desired density (i.e., a green density of >30 vol % (relative to the full density of the final product), more preferably >50 vol % and most preferably >70 vol %) via dry pressing, cold isostatic pressing, or hot isostatic pressing (pressing can be performed with or without the use of a vacuum); and

sintering the resultant green body.

Sintering can be performing, for example, using solid state sintering, such as by pressureless (vacuum) sintering at a temperature of 70-90% of the melting temperature of the final desired oxide phase (such as YAG, Nd:YAG) in a resistively heated furnace (for example, if the melting temperature is 2000° C., the sintering temperature used is 1400-1800° C.). Such pressureless (vacuum) sintering can be used to initiate and promote solid state diffusion and grain growth and the eliminate pores to form a consolidated, solid network of material. Pressureless sintering could be followed by hot isostatic pressing at a temperature of 70-99% of the melting temperature of the final desired oxide phase (such as YAG, Nd: YAG) to further reduce pore content and to obtain an optically transparent ceramic. In the afore-mentioned sintering procedure, the use of a resistant-heated furnace could be replaced with the use of a microwave heating source, whereby the sample is heated to the appropriate temperatures for sintering (70-99% of the melting temperature of the final desired oxide phase (such as YAG, Nd: YAG)) via microwave excitation/absorption of the sintering medium.

In accordance with the process according to the invention, the starting material used to prepare the glass material (e.g., micro-particles) prior to immersion in the reaction solution is a low durability bulk glass containing sufficient amounts of the desired end species, i.e., the insoluble or slightly soluble components. Thus, the starting glass material must contain a sufficiently high weight percentage concentration of the desired insoluble or slightly soluble species so that the reacted material forms an interconnected structure (ideally, a homogeneous, uniform, pore-free, and nano-textured structure). If there is not a high enough concentration of insoluble or slightly soluble species, then the resultant reacted product will exhibit odd microstructures and/or will be too weak structurally for effective use as a precursor material.

For example, the starting glass material generally contains at least 10 wt % or >1-2 mol % of the desired insoluble or slightly soluble species, or more preferably >20 wt %, or most preferably >30 wt %. Generally, the amount of insoluble or slightly soluble species is at most 70 wt %, preferably at most 60 wt %, especially at most 50 wt %. It is desirable to achieve the highest level initial concentration of dopant and insoluble or slightly insoluble specie in the starting glass while still enabling the glass to react via non-uniform reaction at an adequate rate (>1 micron/hour) when placed into an aqueous solution at a temperature of about 0° C. to about 100° C. (that is a temperature between the freezing point and the boiling point of the aqueous solution).

After formation of the starting glass materials into a suitable shape (such as particulates, fibers, microspheres, plates, thin films, thin sheets, rods, fragments, but most preferably micron-sized particulates and/or microspheres), the glass material is treated using a controlled pH aqueous solution to dissolve the soluble components of the starting glass particles. The pH can range from 1-14, more preferably 5-14 and most preferably 6-13. The reaction is preferably performed at temperatures of 0-110° C., more preferably, 25-110° C., and most preferably 40-110° C. An increase in temperature will increase the reaction rate, as the non-uniform reaction is a thermally activated process, the kinetics of which can be described using the Arrhenius relationship.

The aqueous reaction is designed to dissolve the entire soluble component of the glass in a controlled fashion, while selected constituents (i.e., the insoluble/slightly soluble components such as the lasing dopant) of the glass precipitate back onto the remaining glass body. The precipitation occurs because the selected constituents, i.e., the insoluble or slightly soluble components, have very low solubility in the solution, typically less than 0.01 wt %. The solubility limit is controlled by the constituents of the glass and the content of the solution for dissolution. The pH and temperature of the solution, the concentration of the constituents in the glass, and the cations and anions in the aqueous formulation are controlled such that the reaction proceeds in a manner as to have the precipitated species condense onto the remaining glass particle and form a highly uniform, nano-porous/nano-textured reaction product. As a result, the reacted product is approximately the same size and geometry as the initial glass materials (particulates, fibers, microspheres, plates, thin films, thin sheets, rods, fragments, but most preferably micron-sized particulates and/or microspheres).

When using an alkali borate glass, the alkali component(s), i.e., sodium, potassium, lithium, rubidium, and/or cesium, are typically added to the glass batch in the form of the metal oxides or nitrates, hydroxides, etc thereof. Sodium, potassium, and lithium are preferred. The amount of alkali metal oxides can vary within a wide range (0-75 wt %, more preferably 0-50%, most preferably 0-25%), since this component is to be dissolved in the aqueous solutions.

When using an alkaline earth metal-borate glass, the alkaline component(s), e.g., calcium, barium, magnesium and/or strontium, are typically added to the glass batch in the form of the metal oxides or nitrates, hydroxides, etc thereof. Calcium, barium, and magnesium are the typical alkaline earth metals used. The amount of alkaline metal oxides can vary within a wide range (0-75 wt %, more preferably 0-50%, most preferably 0-25%), since this component is to be dissolved in the aqueous solutions.

In some cases it may be desirable to fully avoid the use of alkali and/or alkaline components to minimize the chance for alkali and/or alkaline contamination of the final reaction product (as alkali and/or alkaline ions are often considered deleterious impurities when conducting solid-state sintering). Thus, according to a further aspect of the invention, the initial glass material is a borate glass composition, which is essentially free of alkali metals and/or alkaline earth metals. These glass compositions contain less than 10 wt %, preferably less than 5 wt %, especially less than 1 wt %, e.g., 0.01 wt % or less of alkali and/or alkaline metal oxides.

The amount of borate in the alkali-borate or alkaline earth metal-glass can also vary widely, since this component also is to be dissolved in the aqueous solutions. For example, the amount of B₂O₃ in the glass material before immersion in the aqueous reaction solution can be 25-90 wt %, more preferably 50-90 wt % or most preferably 40-70 wt %.

As one would readily recognize, the total amount of soluble components, including alkali and borate, must not be so high that the remaining amount of insoluble or slightly soluble material is too low to form an interconnecting structure. Furthermore, the total amount of soluble components including alkali and borate, must not be so low that the resulting material is no longer soluble in aqueous solution. Also note that additional soluble species (such as alkaline earth oxides, phosphates, etc) can also be added to produce the soluble glass component.

The lasing dopant is preferably at least one rare earth oxide, including, but not limited to oxides of La, Ce, Pr, Nd, Sm, Eu, Gd, Tb, Dy, Ho, Pm, Lu, Tm, Er and/or Yb, preferably with Nd, Pr, Dy, Tm, Er, and/or Yb, more preferably with Er, Yb, and/or Nd. The amount of lasing dopant is preferably selected so as to provide an amount of lasing ion in the final precursor materials of 0.01-8.0 mol. %. A suitable range for Er is, for example, 0.01 to 0.40 mole %, such as 0.15-0.35 mole %, e.g. 0.28-0.32 mole %. A suitable range for Yb is, for example, 0.1-1.4 mole %, such as about 0.3-1.2 mole %. A suitable ranges for Nd is, for example, 0.01-3 mole %.

According to a further embodiment of the invention, at least one component is Y₂O₃, Al₂O₃, or a combination thereof. According to a further embodiment, the lasing dopant is Nd₂O₃. According to a further embodiment of the invention, the starting glass material, such as microparticles, contain Nd₂O₃,Y₂O₃, and Al₂O₃

As described, the invention provides a process for producing raw materials which are to be used to form opto-ceramic materials by sintering. The starting materials used in the process, for example, glass microparticles, are preferably homogenous glass particles (e.g., having an index variability <1000 ppm, more preferably <100 ppm and most preferably <10 ppm). These particles are then treated in an aqueous solution to form chemically homogeneous, nano-porous, nano-textured precursor materials for use in opto-ceramic sintering.

Starting with an optically homogeneous glass material (i.e., having an index variability <1000 ppm, more preferably <100 ppm and most preferably <10 ppm) will ensure that the final reacted material is also chemically homogeneous. Such chemical homogeneity in the reacted material will then enable a homogeneous opto-ceramic during sintering.

The initial glass particles, e.g., glass microparticles, can be formed by any conventional process such as the processes described in U.S. Pat. No. 6,358,531. See, for example, Example 1 of U.S. Pat. No. 6,358,531 wherein glass microspheres were prepared by first mixing powders of metal oxides together, melting the mixture in a platinum crucible, casting the composition onto a stainless steel plate, crushing the quenched glass, and subjecting the crushed glass to a propane air flame to form microspheres 5 to 15 μm in diameter. To avoid contamination by platinum particles, an Al₂O₃ crucible could be used, or a crucible that is chemically similar to insoluble constituents themselves (e.g., YAG). In general, the particle sizes are preferably 0.1-1000 microns in diameter, more preferably 1-500 microns and most preferably 10-100 microns.

According to further embodiment, the initial microspheres are prepared directly from a melt using a supersonic melt spraying process, such as described in copending and commonly-assigned patent application, entitled “Method for Spray-Forming Melts of Glass and Glass-ceramic Compositions,” [Attorney Docket No. RDD-12], filed even date herewith, the entire disclosure of which is hereby incorporated by reference.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 shows optical microscopy images of spheridized Na₂O—B₂O₃—Y₂O₃ glass being reacted in 0.01M KOH solution as a function of time;

FIG. 2 shows SEM EDS spectra of reacted Na₂O—B₂O₃—Y₂O₃—Al₂O₃ glass particles depleted in sodium and enriched in yttrium oxide and aluminum oxide (base glass is un-reacted Na₂O—B₂O₃—Y₂O₃—Al₂O₃ glass; treated bulk glass is reacted Na₂O—B₂O₃—Y₂O₃—Al₂O₃ glass, and Dust Dark Spot is contaminant un-reacted Na₂O—B₂O₃—Y₂O₃—Al₂O₃ glass); and

FIG. 3 shows the XRD spectra showing crystallization of the Na₂O—B₂O₃—Y₂O₃—Al₂O₃ glass after reaction and after heat treatment (the primary phases are Y(OH)₃, YAl₃(BO₃)₄, Al₂O₃, and Y₃Al₅O₁₂).

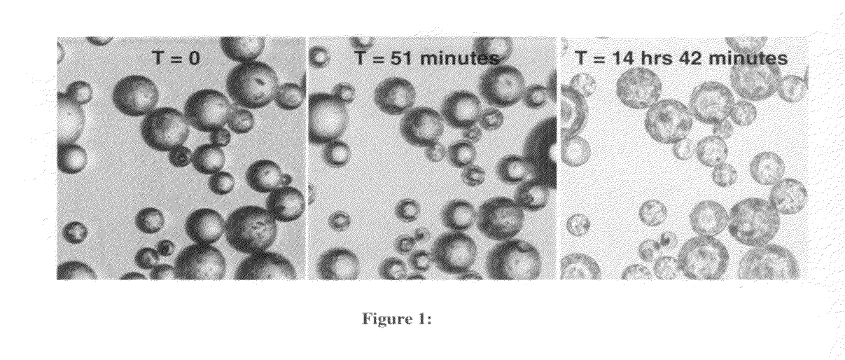

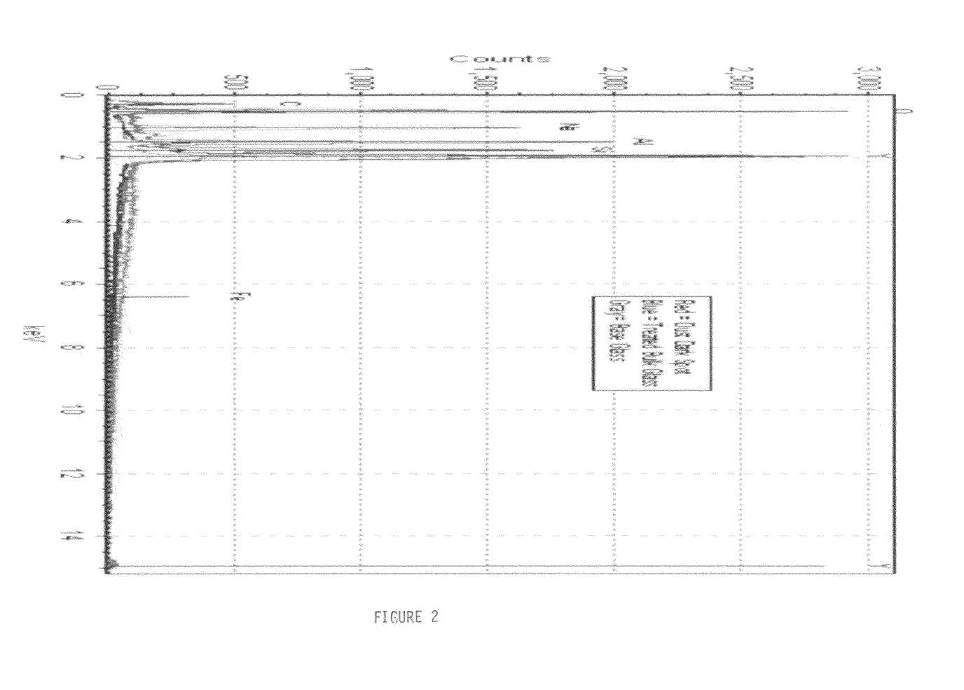

In the process of the invention, the initial microparticles are made from a base glass the components of which have low durability and thus will uniformly dissolve in an aqueous solution. However, this base glass is modified to further contain insoluble or slightly soluble components. For example, the microparticles used in the process can made from an alkali borate glass which is doped with cations that have low solubility in aqueous solutions, such as Y³⁺, Al³⁺, Nd³⁺. These “doped” glasses are then reacted in an aqueous solution such as an aqueous potassium hydroxide solution. The reaction results in non-uniform dissolution of the glass. See FIG. 1 which illustrates the non-uniform reaction of an alkali borate glass that contains Y (see Table 1). As the non-uniform reaction proceeds, the soluble (in this case, borate) phase of the glass is dissolved, while the insoluble cation(s) (e.g., Nd, Y, and/or Al) are precipitated into a chemically homogeneous, nano-porous/nano-textured phase which uses the original particle as a template. See FIG. 2 which shows the SEM EDS spectra of both unreacted and reacted Na₂O—B₂O₃—Y₂O₃—Al₂O₃ glass particles, the latter being depleted in sodium and enriched in yttrium oxide.

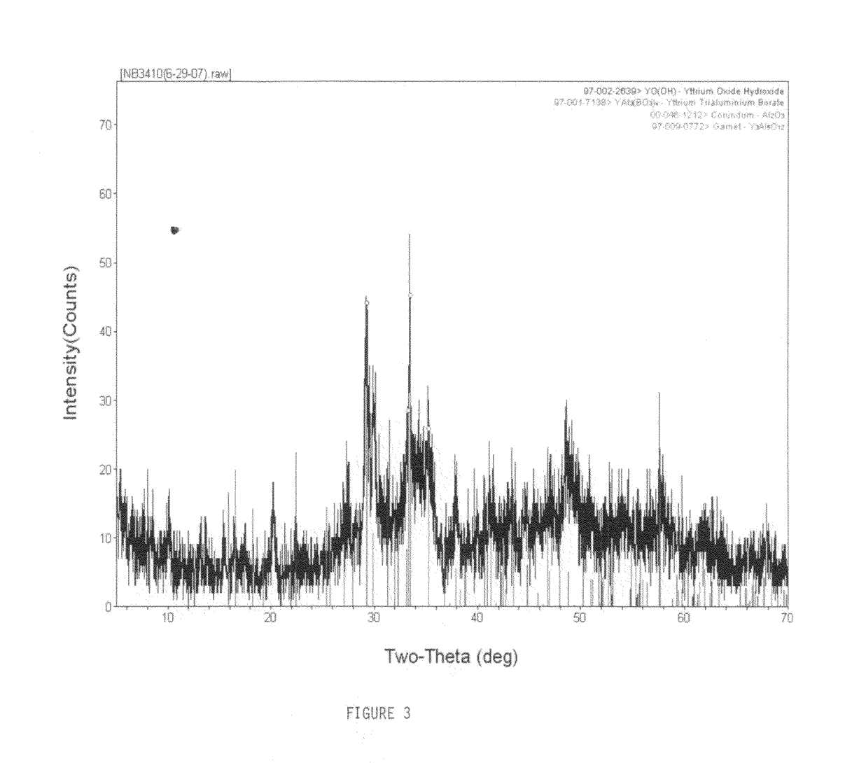

The reaction product is often comprised of a cation-hydroxide chemistry (e.g., Nd/Y/Al-hydroxide₍ₐₘₒᵣₚₕₒᵤₛ₎), which can be subsequently dehydrated/crystallized via heat treatment (e.g., to obtain Nd:YAG precursor material). See FIG. 3 which shows the XRD spectra showing crystallization of the Na₂O—B₂O₃—Y₂O₃—Al₂O₃ glass after reaction and after heat treatment. The overall reaction can be illustrated by the following equation (for a borate glass containing only yttrium):

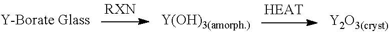

The reaction product can be used in its amorphous or hydrated form for the sintering process, or, as indicated above, the reaction product can be subjected to a heat treatment to dehydrate/crystallize the reaction product. A suitable heat treatment would be to heat the reaction product to a temperature of 300-600° C.

The glass/solution reaction process is such that the size of the reacted particle is substantially the same as the starting glass microparticle (template). Thus, the macroscopic size of the nano-porous/nano-textured reaction product can be controlled via the initial glass forming step (i.e., formation into microparticles, fibers, microspheres, plates, etc). As a result, the size distribution of the initial glass particles can be tailored to assist in particle packing in the manufacture of the subsequent opto-ceramic product

For example, the initial particles to be subject to the solution reaction can be of a bimodal distribution thereby resulting in a bimodal distribution for reacted particles. Such a distribution can be utilized to achieve higher densities for the green bodies used in the opto-ceramics sintering. It also possible to use the starting materials that result in the formation of reacted fibers or even plates, which can then be used as precursors for opto-ceramics sintering.

When using micron-sized particles in the solution reaction, the resultant porous particles are in the form of a free-flowing powder having nano-functionality after reaction and heat treatment. Such an ability to “package” nano functionality into micron-sized particles is very advantageous with respect to powder processing and subsequent sintering. Such materials will facilitate the ability to provide large format (i.e., >10×10×2 cm³), optically homogeneous opto-ceramics for high energy laser applications in a cost effective manner.

Another advantage of inventive process is that the final composition of the reaction product is controlled by the initial concentration and stoichiometry of insoluble (reactive) cations incorporated into the starting glass, i.e. any insoluble cations “doped” into the glass will ultimately be incorporated into the reacted particle. The uniqueness of this attribute is that the initial glass, such as a borate glass, can be doped with multiple insoluble species. For example, the appropriate stoichiometric quantities of Nd₂O₃, Y₂O₃ and Al₂O₃ to form Nd:YAG laser material can be homogeneously melted into the glass. After the solution reaction, each particle will have a highly uniform distribution of each cation to form Nd:YAG. Such a highly uniform distribution will minimize, possibly eliminate, chemical inhomogenity problems that have often plague the conventional process involving sintering of nano-particle powders. The ability to control the final composition of the nano-porous/nano-textured particle by changing the glass “dopants” makes the inventive process a versatile one that can be used to form a variety of chemically homogenous precursor materials for use in opto-ceramic sintering (beyond Nd:YAG laser materials).

In addition to controlling the composition of the nano-porous/nano-textured particles, by modifying the cation input into the starting glass, it is possible to control the composition of the final product by modifying the composition of the aqueous solution. For example, hydroxide-based reaction products are formed for reactions in H₂O, while phosphates or sulfates can be formed by reacting in PO₄³⁻ or SO₄²⁻-containing solutions, respectively.

As noted above, after the porous materials are produced, they can be left as is in a hydrated amorphous form, or they can be optionally be heat treated to form crystalline species (see FIG. 3). On the one hand, the particles in an amorphous form will be compressible and which may lead to increased green body density. Since the reacted particles are hydrated, they will exhibit a certain plasticity which would permit the particles to be compressed prior to sintering, without crushing the particles, and thereby increase green body density. On the other hand, the crystalline form of the material provides the benefit that it is already dehydrated. In addition to controlling the crystalline vs. amorphous nature of the particles, heat treatment can be used to tailor the porosity and specific surface area of the particles.

In summary, the invention provides a glass/solution reaction process suitable for producing precursors for opto-ceramic sintering, wherein the process has one or more of the following attributes:

simplified particle processing (i.e., the resultant reacted particles are easy-to-handle, discrete micron-sized particles with nano-functionality);

control of size/shape control (i.e., the resultant reacted materials have the same shape and size as the starting glass materials);

chemical versatility (i.e., the process is applicable to wide variety of materials based on cations melted into the starting glass and anions in solution); and/or

chemical homogeneity (i.e., the resultant reacted materials are formed from nano-sized domains mixed on the molecular level whereby the initial glass material has an index variability of preferably <1000 ppm, particularly <100 ppm, and most preferably <10 ppm); and high and controllable specific surface area to facilitate sintering (200 m²/g) resultant hydrated, amorphous precursors expected to be plastic, enabling high green densities during pressing; and suitable for industrial scale up (i.e., the technology is based upon traditional high homogeneity glass melting followed by glass/solution reaction, both of which can be conducted on a large scale (tons/day) and in an industrial manner).

### EXAMPLES

### Example 1

A glass containing Na₂O and B₂O₃ in a 1 to 3 ratio with 10 wt % additions of Y₂O₃ is prepared (see Table I for exact composition) by combining reagent grade materials and melting them in a platinum crucible in a resistance furnace. After casting, the glasses are crushed into particles and sieved. Some of the particles are spheridized in a tube furnace to aid in visual observation of the dissolution and precipitation reactions. A glass containing Na₂O and B₂O₃ in a 1 to 3 ratio with 10 wt % additions of Y₂O₃ is prepared (see Table I for exact composition) by combining reagent grade materials and melting them in a platinum crucible in a resistance furnace. After casting, the glasses are ground into particles and sieved. Some of the particles are spheridized in a tube furnace to aid in visual observation of the dissolution and precipitation reactions. The particles and spheres are subsequently reacted in 0.01 M KOH solution for 1 to 18 hours (depending upon particle size). After this time, a visual change has occurred, with the particles “looking” different in digital microscopic pictures (See FIG. 1) as a reaction front forms at the edge of each microsphere and then slowly moves toward the center of each microsphere as a function of time.

### Example 2

Example 1 is repeated except that the starting materials include Al₂O₃, as well as Na₂O, B₂O₃, and Y₂O₃ (see Table I for exact composition).

### Example 3

Irregular particles of formed from the same glass composition as used in Example 2 are immersed and reacted in 0.01M NaOH for 16 hours and then filtered and rinsed in deionized water. The reacted particles are analyzed after reaction using a scanning electron microscope (SEM). The EDS (Dispersive X-ray Spectroscopy) data from the SEM (FIG. 2) indicates that the remaining particles are depleted in Na₂O, and enriched in Y₂O₃ and Al₂O₃, (no changes in B₂O₃ is detectable due to the limitations of the EDS system). The reacted particles are then heat treated to 600° C. for confirmation of crystalline nature of the materials. The X-ray diffraction (XRD) data indicates a complex crystalline material (FIG. 3) with the primary constituent being hydrated yttrium oxide.

TABLE I
Composition of Base Glass Starting Materials in the Examples

| Example | Component | Weight % |
|---|---|---|
| 1 | Na₂O | 20.6 |
| | B₂O₃ | 69.4 |
| | Y₂O₃ | 10 |
| | Al₂O₃ | 0 |
| 2 | Na₂O | 20.6 |
| | B₂O₃ | 69.4 |
| | Y₂O₃ | 5.7 |
| | Al₂O₃ | 4.3 |

While the present discussion has focused on the preparation of precursor materials for manufacturing opto-ceramic materials for high energy laser application, nano-porous solid microparticles can be used in a wide variety of applications. In particular, nano-porous solid microparticles can be used as precursors for the production of porous supports and filter materials.

For example, nano-porous particles can be used to produce catalyst supports, especially supports for high temperature catalysts. They can be used to provide catalyst supports that not only have a high degree of porosity, but also a high specific surface area to provide a large acceptable surface for catalyst loading. Also, by using refractory materials to manufacture the precursor nano-porous particles, the resultant catalyst supports can be used in processes that operate under severe conditions such as high temperatures. g d the composition of the porous media can be controlled by the dopants in the original glass, thus it is possible to produce very refractory materials with high specific surface areas for catalytic activity.

Nano-porous particles can also be used to produce filtration media, i.e., both liquid and gas filtration media. For example, the nano-porous particle produced in accordance with the inventive process can be used for the liquid filtration/separation of monoclonal antibodies from a complex mixture of proteins. Here again, the precursor nano-porous particles can provide filtration media having a high specific surface area.

Further, by using refractory materials to manufacture the precursor particles, the resultant filtration media can be used, for example, at high temperatures and under other severe conditions. For example, the nano-porous particles can be used to produce base resistant filtration media. By controlling by the dopants used in the original glass, one can produce filter media that will not degrade in the presence of strong bases, such as used to clean biotherapuetic filtration media, for example, filtration used in the separation/purification of monoclonal antibodies. By way of example, the starting glass material glass can be doped with Y₂O₃, which is known to be very durable in the presence of strong bases. Thus, the high specific surface area is retained even after cleaning.

The precursor materials can also be used for manufacturing porous filtration media for high through put water filtration. The high specific surface area and the ability to dope the surfaces with anti-bacterial materials make this a possible solution for water filtration media.

The entire disclosures of all applications, patents and publications, cited herein are incorporated by reference herein.

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for preparing porous glass material suitable for use as precursor materials for production of an opto-ceramic element said process comprising:
providing a glass material of a soluble glass composition comprising at least one soluble component, at least one component having low solubility in an aqueous solution, and at least one lasing dopant which also has a low solubility in the aqueous solution; and
immersing the particles in an aqueous solution having low solubility for said at least one component and said at least one lasing dopant, to thereby dissolve substantially all of the soluble portions of the glass material.

2. A process for preparing porous glass material suitable for use as precursor materials for production of an opto-ceramic element said process comprising:
providing a glass material of an alkali-borate glass composition comprising at least one alkali metal oxide, B₂O₃, at least one component having low solubility in an aqueous solution, and at least one lasing dopant which also has a low solubility in the aqueous solution; and
immersing the particles in an aqueous solution having low solubility for said at least one component and said at least one lasing dopant, to thereby dissolve substantially all of the soluble borate and alkali metal portions of the glass material.

3. A process for preparing porous glass material suitable for use as precursor materials for production of an opto-ceramic element said process comprising:
providing a glass material of an alkaline earth metal-borate glass composition comprising at least one alkaline earth metal oxide, B₂O₃, at least one component having low solubility in an aqueous solution, and at least one lasing dopant which also has a low solubility in the aqueous solution; and
immersing the particles in an aqueous solution having low solubility for said at least one component and said at least one lasing dopant, to thereby dissolve substantially all of the soluble borate and alkaline metal portions of the glass material.

4. A process for preparing porous glass material suitable for use as precursor materials for production of an opto-ceramic element said process comprising:
providing a glass material of a borate glass composition, which is essentially free of alkali metals and/or alkaline earth metals, comprising B₂O₃, at least one component having low solubility in an aqueous solution, and at least one lasing dopant which also has a low solubility in the aqueous solution; and
immersing the particles in an aqueous solution having low solubility for said at least one component and said at least one lasing dopant, to thereby dissolve substantially all of the soluble portions of the glass material.

5. A process for preparing porous glass material suitable for use as precursor materials for production of an opto-ceramic element said process comprising:
melting a glass composition comprising B₂O₃, at least one component having low solubility in an aqueous solution, at least one lasing dopant which also has a low solubility in the aqueous solution, and optionally containing alkali metal oxides and/or alkaline earth metal oxides;
producing particles by (a) casting the melted composition, crushing and/or milling composition as casted, and optionally sieving the resultant particles, or (b) direct melt spraying the melted composition;
immersing the particles in an aqueous solution having low solubility for said at least one component and said at least one lasing dopant, to thereby dissolve substantially all of the soluble portions of the glass particles and precipitate the desired products;
rinsing the reacted particles to remove dissolved species and the aqueous solution;
pressing the resultant particles to produce a green body of desired density via dry pressing, cold isostatic pressing, or hot isostatic pressing; and
sintering the resultant green body.

6. A process according to claim 4, wherein said particles are produced by melt spraying using shockwaves.

7. A process according to claim 1, wherein said glass material prior to immersion is in the form of micron-sized particulates and/or microspheres.

8. A process according to claim 1, wherein the starting glass material contains at least 10 wt % of insoluble or slightly soluble species.

9. A process according to claim 8, wherein the starting glass material contains 10-50 wt % of insoluble or slightly soluble species.

10. A process according to claim 9, wherein the starting glass material contains 10-30 wt % of insoluble or slightly soluble species.

11. A process according to claim 1, wherein said at least one component is Y₂O₃, Al₂O₃, or a combination thereof.

12. A process according to claim 1, wherein said lasing dopant is Nd₂O₃.

13. A process according to claim 1, wherein said at least one component is Y₂O₃, Al₂O₃, or a combination thereof, and lasing dopant is Nd₂O₃.

14. A process according to claim 2, wherein the alkali component(s) is a sodium metal oxide, a potassium metal oxide, a lithium metal oxide, or a combination thereof.

15. A process according to claim 1, wherein said lasing dopant is at least one oxide of La, Ce, Pr, Nd, Sm, Eu, Gd, Tb, Dy, Ho, Pm, Lu, Tm, Er or Yb.

16. A process according to claim 15, wherein said lasing dopant is at least one oxide of Nd, Pr, Dy, Tm, Er, or Yb.

17. A process according to claim 16, wherein said lasing dopant is at least one oxide of Er, Yb, and/or Nd.

18. A process according to claim 1, wherein the starting materials are prepared by first mixing powders of metal oxides together, melting the mixture in a crucible, casting the composition to form a glass material, casting and quenching to form a glass material, crushing the quenched glass material, and subjecting the crushed glass material to a propane air flame to form microspheres.

19. A precursor material prepared by a process according to claim 1.

20. A material prepared by a process according to claim 13.

21. An opto-ceramic element produced by the process according to claim 5.
